(19) United States
(12) Patent Application Publication
(10) Pub. No.: US 2021/0082061 A1
(43) Pub. Date: Mar. 18, 2021

(54) DATA GOVERNANCE SYSTEM, MODEL AND PROCESS FOR MULTI-SOURCE FINANCIAL REFERENCE DATA USING AUTOMATED BUSINESS LOGIC

(71) Applicant: S.W.I.F.T., scrl, La Hulpe (BE)

(72) Inventors: Jan Dings, La Hulpe (BE); Thomas Poppe, La Hulpe (BE)

(21) Appl. No.: 16/939,574

(22) Filed: Jul. 27, 2020

Related U.S. Application Data
(60) Provisional application No. 62/899,310, filed on Sep. 12, 2019.

(51) Int. Cl. G06Q 40/00; G06Q 10/10; G06Q 30/00; G06Q 20/40; G06F 16/23; G06F 21/60

(52) U.S. Cl. CPC G06Q 40/12; G06Q 10/10; G06Q 30/0185; G06Q 2220/00; G06F 16/2365; G06F 16/2379; G06F 21/602; G06Q 20/405

(57) ABSTRACT

A system, apparatus and method maximize the accuracy of semi-static data employed by market participants. In various embodiments, a precise definition of multiple reference data elements is stored, and for a given reference data element, a determination is made as to how much of the definition each of a plurality of stakeholders knows about the reference data element, and what the strict logical relationships are between these knowledge limitations. Based on that determination, the reference data element is monitored over time, and a determination is made as to which stakeholder must supply, confirm, challenge or reject which portion of information about the reference data element, and at what time. In various embodiments, each reference data element is defined using automated business logic, and the automated business logic also orchestrates the system processes, resulting in an unmodifiable ledger of all actions taken, all data added, modified or removed, to thereby make the resulting data available to those needing it to proceed with a financial transaction.

### CROSS-REFERENCE TO RELATED APPLICATIONS

The present application claims priority to U.S. provisional application No. 62/899,310, filed on Sep. 12, 2019, entitled “Data Governance System, Model and Process for Multi-Source Financial Reference Data using Smart Contracts”, the contents of which are incorporated by reference herein in their entirety.

### BACKGROUND AND SUMMARY

The present disclosure pertains to financial technology, and more specifically to a data governance system, model and process for multi-source financial reference data using automated business logic.

In financial data management, for a given subject matter such as standing settlement instructions (SSIs), reference data elements can be multi-source: not only known to their “owner”, but also, at least partially, or up to a relevant level of probability, by additional parties. SSIs stipulate via which bank a party can be paid in for a given currency. It will be appreciated that SSIs are used throughout the present disclosure as an example of a multi-source reference data element type. However, the systems, models, and methods as disclosed herein are by no means to be construed as limited to that example. Typically, SSI data elements will include the bank identification code (BIC) for a bank providing the SSI (the SSI “owner”), the BIC for a Nostro (another bank servicing an account in a (typically foreign) currency for the SSI owner), an optional start and end date, the applicable market (Commercial Payments, Forex Exchange settlement, Trade, etc.) and the currency. Current approaches towards the collection and validation of such data: (i) lack solid control over the entitlement of the parties (i.e., staff) providing the data in the name of its owner, and (ii) make no use of the knowledge parties other than the owner have about the same data element or of the various ontological relationships between these knowledge elements. The end result is that, in the field of cash SSIs, for example, an estimated twenty percent of all payment/settlement failures are due to stale, wrong, or missing SSIs, causing an immense cost to the industry.

Currently, SSI data is collected through various channels, each time involving only one party, i.e., the “owner” of the data. Collection of this data can occur through a telephone call to the owner, an e-mail exchange with the owner, or by the owner entering data electronically either in structured or in free format manner. Given the intensive manual labour involved in reaching out to all owners of such data, typically no effort is spent to involve other stakeholders to ensure the data is accurate and up to date, as this would increase the data collection burden. Also, without specific technology to appropriately use each stakeholder's correct level of knowledge, or the correctly defined element in the complete SSI, it would not be feasible to organize, let alone execute this correctly. While the owner should take initiative to inform the market of any changes, in practice the owner must be prompted at various time intervals to reconfirm the data. With this process, there is extreme exposure to consequences of the absence of collective punctuality (missing or stale elements, for example, with no way to distinguish from valid data). In general, while there is limited possibility for other stakeholders of a given data element to contribute, prevent errors or signal probable errors, there is no possibility for a stakeholder to delete data elements, even when the stakeholder knows a stored data element for which their formal acceptance is required can no longer be true. This is, for example, the case of a cash SSI: the Nostro bank mentioned in the SSI might not know whether the account it services is actually the SSI for that currency, for that customer, and might also not know for which market that is the case. That Nostro will know, however, that the owner of a given SSI must be their customer, if the SSI in which the Nostro is mentioned, is to be correct. Today, when the owner of a given SSI is under embargo or otherwise blacklisted, it is not possible for a Nostro bank, mentioned in that SSI, to have that SSI deleted from any cash SSI database.

Among other things, it will be appreciated that the present disclosure reveals a novel system, method and model for maximizing the accuracy of semi-static data, wherein each data element is initially submitted by a single party stakeholder (the owner, or a party legally mandated by the owner), then validated by another stakeholder such as a counterparty (e.g., the Nostro), and depending on the validation result, rejected or accepted and re-submitted for confirmation by the owner. This process is to be repeated until consensus is reached amongst both parties, while a trusted intermediary provides facts on the data elements that assist both parties in assessing the validity of the data sets, then published to tens of thousands of market participants, and then also very regularly (e.g., daily) re-validated by these stakeholders, during the entire lifecycle of the specific data element. While the present disclosure includes details pertaining specifically to cash SSIs, it will be appreciated that the present disclosure can work equally well with other multi-source reference data types, involving a different number and type of stakeholders.

In various embodiments according to the present disclosure, data is collected via the owner (or other mandated party) for specific reference data elements, but all parties that also know about those data elements are forced to become involved in maintaining the data elements in accurate and current form. Further, all parties with knowledge of the reference data elements can be involved in maintaining facts that may be implied by the stored data elements.

In various embodiments, reference data can be centrally managed or managed in a distributed fashion, such as via distributed ledger technology (DLT). In various embodiments as disclosed herein, automated business logic, which can be referred to as smart contracts, for example, is used to orchestrate the involvement of the various stakeholders in the creation and lifecycle of each individual reference data element. It will be appreciated, however, that the DLT can be managed centrally and used as a mechanism to distribute the centrally managed database with all data elements to subscribing parties. In specific embodiments, the specific implementation employing automated business logic can use specific modeling languages such as DAML. In this way, at any given moment during the initial submission phase, or during the entire lifecycle of a given multi-source reference data element, it is clear which party has responsibility and also which actions are allowed or not, or expected, from whom. An audit trail is kept for each reference data element, and the audit trail can differentiate viewing rights among the many stakeholders. For example, the identity of actual operators is only visible to the stakeholders they work for, whereas actions taken and the timestamps and identities of stakeholders will be visible to both. To external parties merely consulting the data, for example, the only visible metadata will be the timestamp of the last validation.

In various embodiments, participants can employ a graphical user interface (GUI) to interact with the system. In other embodiments, participant interaction can be automated via application programming interfaces (APIs). The involvement can be limited to initial set-up followed by infrequent maintenance activities, or it can be a daily activity. The system can allow parties to manually overrule whatever is challenged, for example, by non-100% certain sources, either systematically for a given type of data, or for a given data element. In employing automated business logic, data collection and updates can be automated, and can intercept human mistakes at input as well as fraudulent input/deletions. As described herein, by employing automated business logic, the data validation steps are orchestrated such that, at any given moment, the system exposes which party must act on a given data element, what actions are available to the acting party and whether such actions can be overruled. All actions taken are recorded in a complete audit trail.

In various embodiments, stakeholders are proactively challenged automatically by the present system regarding the need to re-confirm, edit or delete an already published data element. Further, stakeholders can delete data elements for which a necessary condition that they control or know, no longer holds. Specifically for cash SSIs, such deletion can occur without needing agreement from any other stakeholders.

As described, the system, model and method herein maximize the accuracy of semi-static data employed by market participants, not only upon entry but as the data is maintained over time. In various embodiments, the system and method store a precise definition of multiple reference data elements, and for a given reference data element, determine how much of the definition each of a plurality of stakeholders knows about the reference data element, and what the strict logical relationships are between these knowledge limitations. Further, based on that determination, the reference data element is monitored over time, and the system determines which stakeholder must supply, confirm, challenge or reject which portion of information about the reference data element, and at what time. In various embodiments, each reference data element is defined using automated business logic, and the automated business logic also orchestrates the system processes, resulting in an unmodifiable ledger of all actions taken, all data added, modified or removed, to thereby make the resulting data available to those needing it to proceed with a financial transaction.

The computing system(s) associated with the present disclosure can include one or more processors executing instructions stored in one or more memory modules to carry out the requested and required functions disclosed herein.

### BRIEF DESCRIPTION OF THE DRAWINGS

FIG. 1 is a schematic system diagram in accordance with various embodiments of the present disclosure.

FIGS. 2 and 3 are a diagram illustrating processes according to embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Example embodiments such as disclosed herein can incorporate a controller having a processor and an associated memory storing instructions that, when executed by the processor, cause the processor to perform operations as described herein. It will be appreciated that reference to “a”, “an” or other indefinite article in the present disclosure encompasses one or more than one of the described element. Thus, for example, reference to a processor encompasses one or more processors, reference to a memory encompasses one or more memories, reference to a command encompasses one or more commands and so forth.

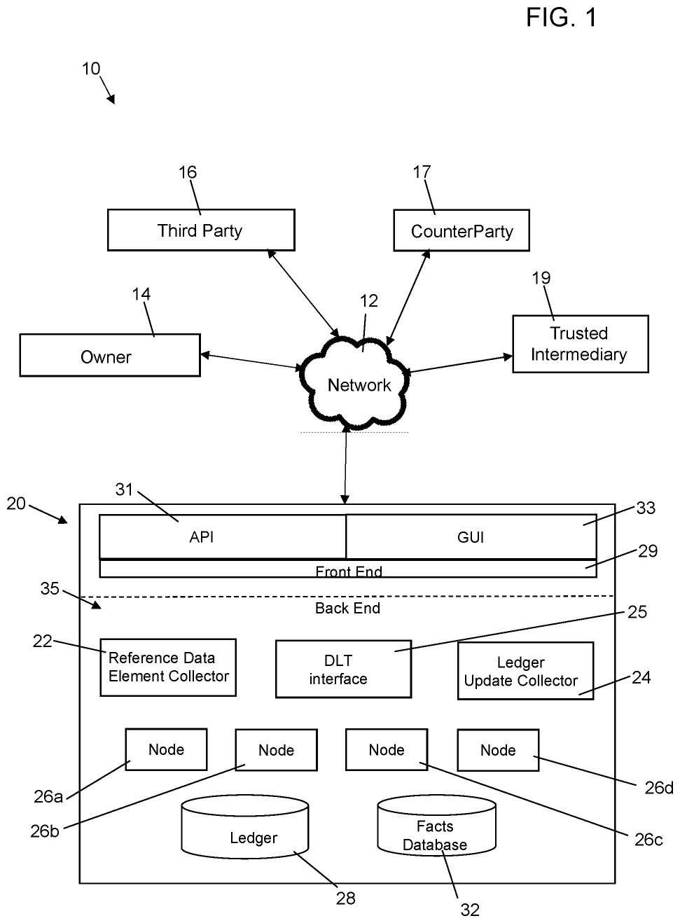

FIG. 1 is a schematic diagram illustrating an exemplary system 10 for facilitating data collection, verification, accuracy maintenance and related transaction activities in accordance with various network-enabled and/or online embodiments of the present disclosure. As shown therein, embodiments of the present disclosure can comprise various components and/or modules that can be implemented in hardware, software, firmware, or combinations thereof. FIG. 1 illustrates an exemplary high-level network 12 with exemplary users and/or external computer systems 14, 16, 17, 19 that can interact with a system 20. In various embodiments, users can access system 20 using client computing devices, such as personal computers (PCs), tablet computers, laptops, mobile communications devices (including smartphones), personal digital assistants (PDAs) and other forms, for example. In various embodiments, participants can employ a graphical user interface (GUI) 31 to interact with the system 20. In other embodiments, participant interaction with the system 20 can be automated via one or more application programming interfaces (APIs) 33. It will be appreciated that the system of the present disclosure can incorporate necessary processing power and memory for storing data and programming that can be employed by the processor to carry out the functions and communications necessary to facilitate the processes and functionalities described herein. The users can include an owner 14, a third party consulting the database 16, a Counterparty 17 and a trusted intermediary 19 as described elsewhere herein. While other or additional user types may be involved in other scenarios, it will be appreciated that the system as described herein is dynamic and able to adapt to different categories and/or types of reference data elements, for example. It is thus possible for the present system to involve and be available to an unlimited number of users and user types (e.g., different market participants).

Users can enter commands and information into respective client computing devices through a user interface including traditional input mechanisms, such as a keyboard and pointing device, commonly referred to as a mouse, trackball or touch pad. One or more monitors or display devices can be provided with the computing devices as will be understood in the art. In addition to display devices, the computing devices can also include other peripheral output devices, which may be connected through an output peripheral interface. The computers implementing the system 20 of the present disclosure may operate in a networked environment using logical connections to one or more remote computers, the remote computers typically including many or all of the elements described above. Publicly available networks such as the Internet, for example, as well as a private network managed by an intermediary third party, can provide interconnectivity for various devices to communicate with one another.

As shown in FIG. 1, the system 20 can include a back end 35 having a reference data element collector 22, a ledger update collector 24, a distributed ledger technology interface 25 and various automated business logic nodes 26a-d and associated ledger 28 for implementing reference data element storage, updates and audit trails, for example. In various embodiments, system 20 includes a specific computer server resident at a data center that is configured to track and/or otherwise maintain reference data elements, electronically coupled to a plurality of external or internal computing nodes 26a-d which are synchronized and maintain the distributed ledger 28 in accordance with a consensus process. Various DLT solutions can be employed with the system of the present disclosure, as will be understood in the art.

As further shown in FIG. 1, an intermediary 19 such as SWIFT, the international messaging service provider employed by banks and other financial institutions, acts as one of the stakeholders. The intermediary 19 can analyze data traffic and inputted data elements, such as those of data owners 14 to warn parties of any detected mistakes, such as typographical errors made by the operator at a bank (the SSI “owner”) when initially inputting data elements such as SSI data elements. An additional stakeholder, such as a Counterparty 17 identified above, can further employ an operator and a supervisor, who will not enter new data, but can evaluate data pertaining to reference data involving the Counterparty and can accept or reject any data inputted by the owner; they will typically accept it when, for example, a necessary (but not sufficient) condition for the SSI to be correct, is true, namely that their institution serves a Nostro account for the owner. Staff at the Counterparty can also propose deletion of an already published reference data element, for example, if the Counterparty (e.g., Nostro) has become aware of facts that would render the stored SSI data element for a given SSI as inaccurate, outdated, or even unwanted (e.g., when there is an embargo in place concerning the SSI owner, making it illegal for that Counterparty to still serve that party). It will be appreciated that the trusted intermediary 19 can provide warnings and/or notifications to any of the stakeholders as it reviews data on a regular basis (e.g., daily), whereupon the system can record that the stakeholders have received and read the warnings and/or notifications sent by the intermediary 19. In various embodiments, the intermediary 19 cannot change or delete any data element without confirmation from a stakeholder.

It will be appreciated that the owner 14 inputting the reference data has full knowledge of their own reference data, but can submit typos, or forget to update or delete reference data elements. For example, the Counterparty 17 knows whether a party has an account with them and knows if the service they provide would allow usage of that account as an SSI but cannot always know with complete certainty if the account they service is indeed an SSI. It will be appreciated that all SSIs are account relationships, but not all account relationships in a given currency, are an SSI. The submission of an SSI that does not correspond to an account serviced by the Counterparty can be rejected by that Counterparty as a human mistake made by the SSI owner. As noted, the trusted intermediary 19 has access to traffic stats as well as stored agreements created in one or more Relationship Management Applications (RMAs) between parties that manage which message types are permitted to be exchanged between the parties. Such information and documentation can be stored in a Facts database 32, which can be accessed by the trusted intermediary 19 directly or through system 20 as shown in FIG. 1.

The existence of an SSI leaves behind, in most cases, specific fingerprints in a traffic stats database as well as in an RMA database, which are represented by way of example as Facts database 32 in FIG. 1. At any moment in time during the creation steps of an SSI, as exemplified above, the trusted intermediary can validate (positively or negatively) an SSI that does (or does not) seem to have left such fingerprints. As noted above, every “negative validation” by the trusted intermediary is to be explicitly acknowledged by the appropriate operator(s), allowing the trusted intermediary to prove that the corrective feedback was made available, when, and to whom. In practice, the operator(s) at any of the stakeholders will, after acknowledging the negative validation or warning from the trusted intermediary, either correct their input, correct their action, or alternatively explicitly overrule the trusted intermediary. For example, the existence of an SSI leaves behind fingerprints in the vast majority of cases, but not all; an SSI can therefore be published if both (or more, where applicable) stakeholders involved explicitly overrule (e.g., in a forced four-eyes control for each of them) the trusted intermediary, after being forced to take notice of the warning issued by the trusted intermediary.

It will be appreciated that any proposed deletion of a reference data element will be a unilateral command (for example, an SSI owner cannot be forced to stay as the customer of a given Counterparty (e.g., Nostro), and a given Counterparty (e.g., Nostro) cannot be forced to keep an unwanted customer). In various embodiments, the trusted intermediary can challenge a deletion if the observed traffic suggests that the proposed candidate reference data element for deletion is actually used, such that there could be human mistake or fraud (e.g., sabotage) behind the deletion command, or the choice of the element that is to be deleted.

The reference data element collector 22 facilitates reference data element information collection. Owners of SSI information, for example, can initiate the storage of SSI information via collector 22. The ledger update collector 24 can receive updates to reference data element information stored in the system and can produce and update an audit trail for each reference data element. Such updates may be prompted, for example, by the trusted intermediary 19, which monitors the stored data regularly and notifies one or more parties if a stored reference data element requires review or is perceived to contain erroneous or outdated information, as noted above.

The distributed ledger technology (DLT) interface 25 facilitates deploying and updated automated business logic components, synchronizing and maintaining distributed ledger (e.g., 28) in accordance with a consensus process as part of system 20.

It will be appreciated that the system of the present disclosure operates to collect reference data element information and maintain and validate the information automatically and frequently to enable transactions using the reference data element(s) to proceed quickly and without error. By enforcing participation among stakeholders as described herein, the present system solves a technical challenge and maximizes the amount of time the most accurate and up-to-date reference data element information is available, thereby facilitating a much higher rate of successful settlements.

The ledger 28 in FIG. 1 hold records related to users and their information and related contracts, including where the information was obtained, what format it is stored in, what credentials are required for access, and other information and functions. Depending upon the embodiment, user profiles can be maintained in a separate system.

It will be appreciated that an operator working for a data owner stakeholder (e.g., a bank) 14 can submit, edit and delete data elements. For example, SSI data elements will typically include the bank identification code (BIC) for the SSI Owner, the BIC for its Nostro, the currency, an optional start and end date, the applicable market, and other data elements such as the national clearing code, a SWIFT code, e-mail recipients for the bank, etc. It will be appreciated that the individual operator may have a supervisor who may need to reject or approve data entered by the operator as part of the workflow process in accordance with the present disclosure. Depending on the embodiment, this can be truly a supervisor in the hierarchical sense, or a colleague with the same entitlements as the operator, but essentially a different person, to ensure the four-eyes principle of any data input or actions taken in the team.

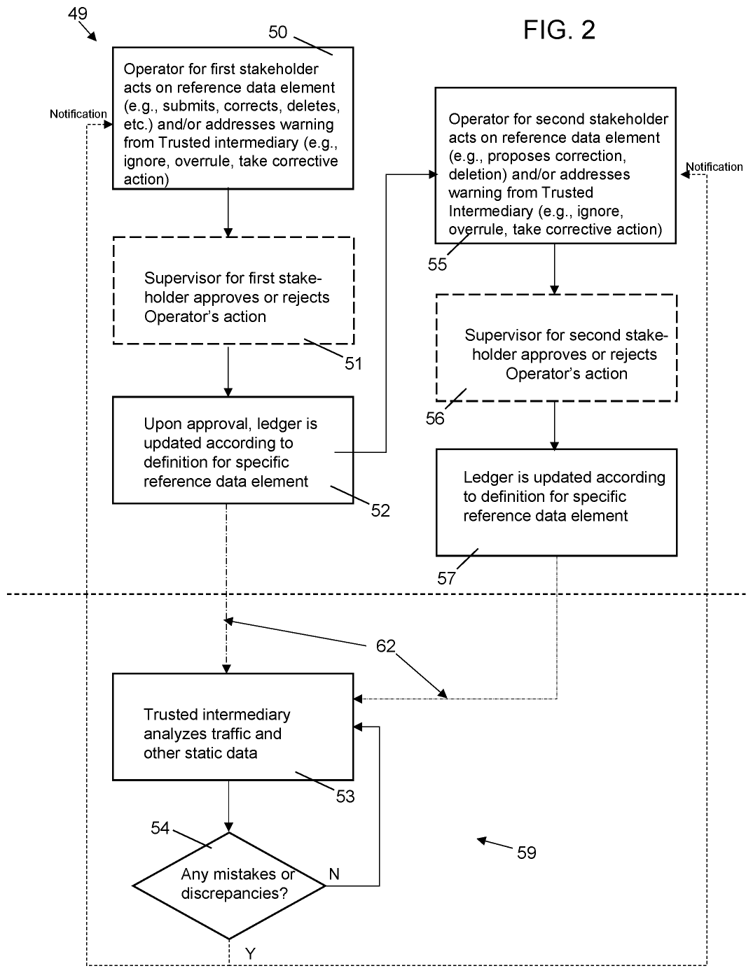

FIG. 2 illustrates an exemplary process flow in accordance with aspects of the present disclosure, including a reference data negotiation process 49 and a third-party notification process 59. As can be seen at 50 in the reference data negotiation process 49, an operator for a first stakeholder (e.g., an Owner 14) acts on a reference data element (e.g., submits, corrects, deletes, etc.) and/or addresses a warning from the trusted intermediary (e.g., ignore, overrule, take corrective action) regarding a reference data element. The reference data element has a definition as described elsewhere herein. In various embodiments, the warning can be in the form of a received notification from the third-party notification process 59. As at 51, a supervisor for the first stakeholder approves or rejects the operator's action. In various embodiments, the supervisor approval is optional as noted by the dashed lines for box 51. As at 52, if the supervisor approves or if no supervisor approval is necessary, the ledger is updated according to the definition for the specific reference data element. For each state a reference data element can be in, the system during its entire lifecycle, the system defines who has access to view or is allowed or expected to take a specific action with respect to that reference data element.

As at 55, an operator for a second stakeholder (e.g., Counterparty 17) can view the updated ledger for the specific reference data element that has just been updated by the first stakeholder (e.g., Owner 14). In various embodiments, the second stakeholder can also operate based on a received notification from the third-party notification process 59. The third party notification process 59 can issue one or more monitoring notifications to the second stakeholder based on input about a reference data element from the first stakeholder (e.g., an Owner) or a third stakeholder (e.g., the trusted intermediary). The operator for the second stakeholder can then act on the reference data element (e.g., propose correction, deletion), whereby upon acceptance by the operator's supervisor as at 56, the ledger is again updated according to the definition for the specific reference data element, as at 57. In various embodiments, the supervisor approval is optional as noted by the dashed lines for box 56. Separately, as at 53 and as part of the third-party notification process 59, the trusted intermediary 19 can monitor and analyze traffic and other static data. While this monitoring can be performed based on, or after, the ledger is updated as at 52 and/or 57 (as indicated in dashed lines at 62), the monitoring can also be performed separately based on the Facts service 32 and other static data. If an error or discrepancy is perceived as at 54, the intermediary 19 can send one or more appropriate notifications (e.g., to the Owner 14 or Counterparty 17). The first and/or second stakeholders (e.g., Owner 14 and/or the Counterparty 17) can ignore, overrule or take corrective action in response to the notification, and this action or inaction is then added to the audit trail for the reference data element. With further reference to 54, if the intermediary does not detect any error or discrepancy, it continues to monitor the traffic and other static data as at 53.

It will be appreciated that each reference data element can have a reference data element type (e.g., an SSI reference data element) and in updating the ledger as at 52 and/or 57 in FIG. 2, for example, the system can associate the definition with the reference data element type and determine at least a portion of the definition each of the first and second stakeholders knows about the type of reference data element. For example, in the case of a cash SSI, the Nostro bank mentioned in the SSI might not know whether the account it services is actually the SSI for that currency, for that customer, and might also not know for which market that is the case. However, that Nostro will know that the owner of a given SSI must be their customer, if the SSI in which the Nostro is mentioned is to be correct. The system can also determine one or more strict logical relationships between at least a portion of the definition and what each of the first and second stakeholders is defined to know about such type of reference data element. Notifications provided upon detection of mistakes or discrepancies as at 54 in FIG. 2 can trigger at least the first and second stakeholders to supply, confirm, challenge or reject at least a portion of information about the reference data element. Further, according to various embodiments of the present disclosure, the notifications can determine a time by which the stakeholder must supply, confirm, challenge or reject at least a portion of information about the reference data element.

In various embodiments, the system can administer the reference data element via a programmed computer protocol that digitally enforces the adherence of the stakeholders to a data governance model defined for each of the plurality of types of reference data elements. The data governance model can specify, for example, the number and type of stakeholders for the reference data element type and each stakeholder's rights and duties at each moment in the lifecycle of a subject reference data element of each reference data element type. The rights and duties can include, for example, the right to consult the subject reference data element and metadata about the subject reference data element, and the duty to take action to ensure that the complete and correct set of reference data elements for each reference data element type is available to the stakeholders. The programmed computer protocol can produce an immutable audit trail of stakeholder actions.

As an example, at least one of the reference data element types can be a Cash Standing Settlement Instruction (Cash SSI) type, which can be defined as a statement by a given party (e.g., Cash SSI Owner) that any cash payment or settlement in a given currency and for a given type of transaction are to be executed on their account with a Nostro bank mentioned in that specific SSI statement. In this example, for the Cash SSI type, the first party is a Cash SSI Owner stakeholder, the second party is a Cash SSI Nostro stakeholder, wherein a provider of a transaction messaging network is a third stakeholder, and wherein the data governance model for the Cash SSI type provides a Cash SSI duty for the Cash SSI Nostro stakeholder to accept or reject any reference data element of the Cash SSI type, and a Cash SSI right to unilaterally delete any reference data element of the Cash SSI type without needing any agreement from the Cash SSI Owner stakeholder.

As a further example, an authorized operator (e.g., 14 in FIG. 1) enters a new SSI, providing the necessary parameters (i.e., owner, currency, Counterparty, applicable market, and optionally a start date, end date and a “preferred” flag). This operator is authorized to do so for a given business unit belonging to the entity employing him or her. Immediately when the command is entered, a trusted intermediary (e.g., 19 in FIG. 1) compares this to one or a plurality of data sources in the Facts database 32, which in the current embodiment regarding SSIs as an example of multi-source reference data, contains: (1) a table extracted from traffic stats and (2) a relationship management application (RMA) database. Regarding (1), the trusted intermediary can look on a daily basis for any number of days in the past to check if the most relevant “fingerprint” that a live SSI leaves behind in traffic is indeed observed. The facts table (1) can map the trusted intermediary analysis as a binary yes or no, for example. The facts table can include the RMA database where, for example, the trusted intermediary may centrally store all RMA agreements explicitly negotiated between two messaging users (e.g., users who use the SWIFT messaging system) that one party will accept and process messages of a given type from the other party. This is not about observed traffic between two parties, but about an explicitly defined possibility for a given message type to be accepted for processing, by a given party, when sent by the other party. A live SSI between Owner 14 and Counterparty 17 will leave behind the fingerprint that there is an RMA agreement such that Owner 14 can in principle, even if not frequently needed, send messages of type lxx or 2xx, to Counterparty 17. Failing such an agreement, an SSI is unlikely. This table, too, can be a binary one. Only if the combination of the two is Y+Y (i.e., “yes” and “yes”), or Y for RMA and “no knowledge” (e.g., because for an SSI with a future activation date, no traffic can be there yet), the trusted intermediary will remain silent. For any other combination, the trusted intermediary will issue a warning, in real-time.

The operator at Owner 14 sees the warning from the trusted intermediary. In various embodiments, the operator cannot do anything without first acknowledging the message has been read (and thereby providing a proof for the trusted intermediary that the warning information was read). The operator can (a) correct/edit the first attempt because the trusted intermediary intercepted indeed some typo, (b) ignore it, or (c) do an explicit “overrule” for a period of time (e.g., one month), for example. Overrule may occur, for example, if the trusted intermediary's information is not current, or if the relevant data is traveling over another network so the trusted intermediary would not see it (e.g., an internal network of the bank, or the internet). When the operator performs an edit, again the trusted intermediary will validate in real-time, and force the operator to acknowledge that validation if it is negative.

A supervisor (or colleague) of the operator helps ensure a “four eyes principle” according to various embodiments, where two separate individuals view details of the potential action. The supervisor receives a notification (e.g., via regular e-mail) that his or her attention is requested on a few items, and sees first the trusted intermediary warnings, if applicable. The supervisor, too, must first explicitly acknowledge them before getting access to any command. The supervisor can either agree with the trusted intermediary's remark, that his colleague overruled, and send the proposal back to that colleague, with a comment, or the supervisor can also overrule it, so the two colleagues agree on what is submitted. It is also possible that there is some time between the actions of the operator and the supervisor, such that the trusted intermediary has another opinion in the interim. For example, if a missing RMA has been created, the trusted intermediary stays silent, or if an RMA agreement was accidentally deleted, the supervisor gets a negative validation from the trusted intermediary. The supervisor must acknowledge it, and the item goes back to the supervisor's colleague to start from the beginning.

A duly authorized operator at the Counterparty 17, authorized for approvals, is then notified that some candidate proposal needs attention. The operator will also get the negative validation from the trusted intermediary if that is applicable at that moment and is required to acknowledge it. The operator can propose to reject the proposed SSI (with a proposed message back to the Owner), or to approve it. In either case, that will only happen if the operator's supervisor or authorised colleague actually agrees. The errors may be, for example, typographical errors, or mistakes where one branch of the Counterparty (e.g., Nostro bank) is mentioned instead of the correct one, or where an operator confuses the correct Counterparty (e.g., Nostro bank) with another one having a similar sounding name, or where there is no, or not the right type of, customer relationship between the Owner and the apparent Counterparty. In the extreme case, the Counterparty catches a bank that for some reason has a hard time finding a bank that wants to be their Counterparty (e.g., due to bad status or embargo).

The supervisor of the operator at the Counterparty is notified that some proposal needs attention, and the supervisor accesses these. The supervisor, too, must acknowledge any negative validations from the trusted intermediary if applicable at that time (they might become applicable just at that moment). If the supervisor agrees with the proposed action (accept/reject), that action gets executed, and if not, the item goes back to the operator. If they agree to accept the SSI, the trusted intermediary publishes it via the DLT interface 25.

It will be appreciated that not all information related to a given reference data element will be visible to the same degree to all parties. Each party (e.g., Owner, Counterparty) can see which institution did what, when. However, only the institutions employing them can see the names of the individual operators involved. Any third party would simply see nothing at all, until the trusted intermediary publishes the reference data element. When published, that third party sees the last day on which there was a trusted intermediary validation that was either positive, or negative but explicitly overruled by the parties involved.

Once the reference data element is published, on a regular basis (e.g., daily), the trusted intermediary re-runs the validation. Additionally, the trusted intermediary can send regular (e.g., quarterly) requests to the owner, to explicitly reconfirm the reference data element. This reconfirmation request mechanism can be used in cases where the regular validation is not fully trustworthy, such as, for example, with SSIs for currencies for which statistics reveal that there is no frequent traffic of type (e.g., statement) from the Counterparty to the Owner. That reconfirmation can also be redone by the Counterparty in question. In various embodiments, this will not be applicable to cases where traffic proves that it is not relevant to ask for a reconfirmation. But, for example, in case the normal traffic pattern is monthly, with sometimes two months in between two statements, it may be necessary, to prevent “stale” SSIs to remain published.

Reference data elements that went through the above process can be tagged as such, to distinguish them from those that did not (yet). A similar process can be provided for deletions, but may be set up so as to require only a four-eyes approval by either the owner (e.g., the Counterparty cannot retain customers that want to go away), or the Counterparty (a Counterparty is free to get rid of unwanted customers, possibly under embargo, for example). Recently deleted items can also be highlighted explicitly for all parties.

It will be appreciated that all steps taken trigger an addition to the audit trail, kept for that reference data element, on the ledger. For each step, the system defines what the change was in the state diagram related to that data item, and for each state, the system defines which commands are possible in that state, and what the profile must be of the operator taking that step.

In various embodiments, the system as disclosed herein employs a front-end application 29, a backend application 35, a Facts service 32 and a DLT network (e.g., nodes 26a-d and ledger 28 in FIG. 1).

The front-end application is responsible for providing the GUI functionalities (e.g., via 33) that allow users to interact with the solution. It will be appreciated that the reference data collector 22 and ledger update collector 24 in FIG. 1 can employ one or more front end applications 29. The front-end application 29 can operate in a regular Internet browser and facilitates user authentication. In various embodiments, the user profile may contain a unique identifier and a list of BIC11s belonging to the organization (identified with an 8-character BIC, or “entity”) to which the user belongs, and hence identify the reference data elements they can take action on.

The user profile information can be stored as follows: name and codes for properties and permissions and the practical meaning of these codes and permission is used in automated business logic components and reflect agreements between the user and the organization to which the user belongs. Hence, the automated business logic components define and control which tasks can be executed on this solution, for a given user. The automated business logic components can be stored in distributed fashion via nodes 26a-d and ledger 28, for example.

The front-end application also allows a given user to visualize all the SSIs to which the user has access, either to manipulate the content or the state of the SSI, or to view (read-only). In various embodiments, the SSIs visible to a user can be grouped in different sections, each corresponding to a given life cycle status applicable to a given SSI.

The front-end application 29 also allows access to reference data elements for which the logged in user can perform actions. Access results in a screen that allows manipulating the reference data element to, for example, update the data of the SSI, acknowledge that a challenge was read and/or evolve an SSI in its life cycle (e.g., approving, rejecting, propose/reject a deletion . . . ).

In various embodiments, the front-end application 29 also provides a filtering mechanism that allows to search through the entries on the lists of displayed reference data elements. It allows the user to enter any relevant search/filtering criteria (e.g. Owner BIC, Currency, Activation date, Correspondent . . . ). The classification defined above can be enriched with a marker to indicate that a reference data element requires the attention of the user that is currently logged on. This marker can be refreshed with every new screen refresh (e.g., a red counter, in the case of GUI-based access).

The backend application 35 orchestrates data fetching from, and updates to, the ledger 28 and the Facts service 32, which is the service providing the data available to the trusted intermediary 19 (e.g., traffic stats and RMA data). This backend application 35 can expose APIs that are used by the front-end application, or any other third party. In various embodiments, the APIs can be divided into the following groups:
reference data element operations: APIs related to the management of reference data elements.
Facts operations: Listing facts, available from central trusted intermediary applications, and related to reference data elements.
User operations: Login, logout, retrieve user information.

The Facts service is responsible for providing the information used by the trusted intermediary to validate or challenge a reference data element action (e.g., traffic statistics and RMA database). The Facts service involves information that the trusted intermediary, as a stakeholder, can extract from multiple other services (e.g., using business intelligence and RMA information), for example. The extracted data can be processed in order to map them on a binary value. While a fully positive (i.e., a positive valuation from all extracted data) will not trigger any explicit notification to the owner or correspondent, any combination containing one negative value (n/y, n/y, or n/n) will trigger its own specific negative valuation.

In most cases, multi-source reference data types will have a status defined as public, limited, or confidential. From the perspective of the SSI example:
1. Published SSIs are public. A user needs only to have paid for the service to see them. The published SSIs are read-only.
2. SSIs that are still being produced, between the Owner and the Counterparty, are only visible to those two institutions. Similarly, as long as the discussion is only internal at the Owner's end, such data is only visible to that Owner.
3. Any discussion between operators (or operator and supervisor) of the same institution, at either side, is visible only to that institution. The neutral trusted party (e.g., SWIFT) can see everything, and intervenes when it knows something that has a sufficient likelihood to be in contradiction with what is proposed by either side.

In various embodiments, the commands required to execute the entire workflow, from create/edit/approve/reject/search to possibly delete are assigned to personal operator profiles that the institutes involved can assign. It will be appreciated that a four-eyes principle will normally be employed, as noted above. By doing this in an orchestrated fashion across all stakeholders instead of only the owner of the data element, and with a system and architecture that can keep track automatically of current and upcoming data maintenance responsibility across all stakeholders, the presently disclosed system, method, model and apparatus assist in resolving the settlement failure problem noted above.

The DLT network is the storage layer of the solution and contains the business logic (e.g., in the form of smart contracts). This allows for usage of DLT technology to take care of the actual distribution of the data; the network can contain any number of nodes, implying that also a single node is possible, resulting for a number of practical aspects in a single central database, when that is desirable. It will be appreciated that the nodes 26a-d and ledger 28 of FIG. 1 can act as the DLT network in various embodiments. The DLT network is responsible for (a) distributing the data amongst various nodes in the network (in embodiments, as mentioned above, there can be only one node, resulting in a single centralized database), (b) orchestrating the working of the automated business logic components that are to guarantee the correctness of the data, and (c) ensuring the immutability of the data.

### DLT-Friendly Data Distribution

Every automated business logic component has in it a definition of parties which have access rights to its embedded information and contractual clauses. Based on those rights, all data being generated through the execution of one or more business logic component functionalities is distributed to the nodes where parties (which have corresponding rights and obligations) are hosted. It will be appreciated that specific implementations for creating automated business logic components can be capable of integrating with both centralized as well as distributed ledger technologies (e.g., as in FIG. 1). Hence, the term DLT-friendly data distribution, in regard to what is meant by nodes above, is dependent on choices towards the ledger system deployed to take care of data distribution, whereas the business logic components take care of the data accuracy.

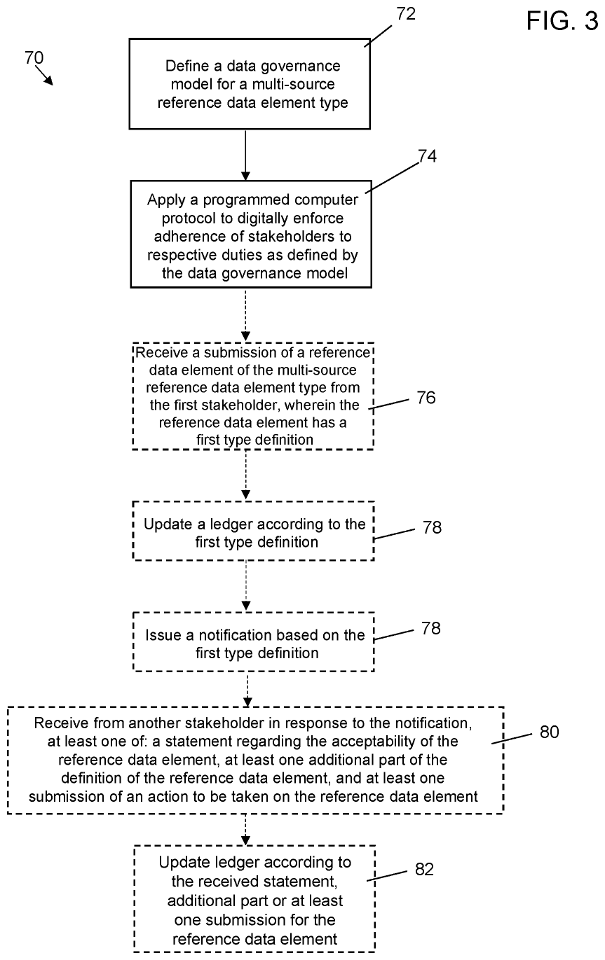

In various embodiments, the system and method described herein facilitate consistent accuracy of multi-source financial reference data. This facilitation can be provided as shown in diagram 70 of FIG. 3, wherein at 72, a data governance model is defined for a multi-source reference data element type, wherein the data governance model definition comprises multiple stakeholders, including for example a first stakeholder such as an owner and a second stakeholder such as a counterparty. The data governance model can further be defined by one or more rights and one or more duties for each of the first and second stakeholders, wherein each right and each duty relate to each of multiple reference data elements of the multi-source reference data element type. This facilitation can further be provided, as at 74, by applying a programmed computer protocol to digitally enforce adherence of the first and second stakeholders to their respective duties as defined by the data governance model. The data governance model can be defined by a user such as the third-party intermediary 19 of the system 20 in FIG. 1, for example.

It will be appreciated that each right and each duty relate to each of multiple reference data elements during the respective lifecycles of each of the plurality of reference data elements in order to ensure reference data element accuracy and prevent unauthorized access. The data governance model can further define a portion of a definition of one or more reference data elements that the first stakeholder can know, a portion of the definition of one or more reference data elements that the second stakeholder can know, and a strict logical relationship between at least a portion of the definition of one or more reference data elements and what each of the first and second stakeholders is defined to know about the one or more reference data elements.

In this regard, in various embodiments and with reference to FIG. 3, the system and method can operate so as to receive a submission of a reference data element of the multi-source reference data element type from the first stakeholder as at 74, wherein the reference data element has a first type definition, update a ledger according to the first type definition as at 76, issue a notification based on the first type definition as at 78, receive, as at 80, from another stakeholder in response to the notification, at least one of: a statement regarding the acceptability of the reference data element, at least one additional part of the definition of the reference data element, and at least one submission of an action to be taken on the reference data element, wherein the at least one action is one of addition, correction, or deletion, and, as at 82, update the ledger according to the received statement, additional part or at least one submission for the reference data element.

It will be appreciated that aspects 74-82 can be optional as noted by the dashed lines. It will further be appreciated that an audit trail of stakeholder actions can be produced that provides digital evidence of adherence, wherein the audit trail is cryptographically protected against modification.

In a specific example, the reference data element type comprises a Cash Standing Settlement Instructions (Cash SSI) type, wherein the Cash SSI type is defined as a statement by the first stakeholder that any cash payment or settlement in a first currency and for a first type of transaction is to be executed on an account with the second stakeholder, wherein the second stakeholder is defined by the statement. For the Cash SSI type, the first stakeholder can be a Cash SSI Owner stakeholder, the second stakeholder can be a Cash SSI Nostro stakeholder, a provider of a transaction messaging network can be a third stakeholder, and the data governance model for the Cash SSI type provides a Cash SSI duty for the second stakeholder to accept or reject any reference data element of the Cash SSI type, and a Cash SSI right to unilaterally delete any reference data element of the Cash SSI type without needing any agreement from the first stakeholder.

It will thus be appreciated that the present disclosure provides a system, model and method that stores a precise definition of each reference data element, determines how much of the definition each of the stakeholders knows about each reference data element, by definition, and what the strict logical relationships are between these knowledge limitations. Further, based on that determination, the system determines which stakeholder must supply, confirm, challenge or reject which portion of information about the reference data element, and at what stage. The strict succession of statuses is defined for each reference data element in automated business logic that also orchestrate the system processes, resulting in an unmodifiable ledger of all actions taken, all data added, modified or removed to thereby make the resulting data available to those needing it to proceed with a financial transaction.

It will thus be appreciated that embodiments of the present disclosure provide, in part, a method, model and system for maximizing the accuracy of multi-source financial reference data using automated business logic, involving the receipt of a submission of a reference data element from a first stakeholder, wherein the reference data element has a definition; updating a ledger according to the definition; issuing, to at least a second stakeholder, at least one monitoring notification related to the reference data element; receiving, from the second stakeholder, at least one statement regarding the acceptability of the reference data element, at least one additional part of the definition of the reference data element and at least one submission of an action to be taken on the reference data element, wherein the action is one of an addition, correction or deletion; and updating the ledger according to the received statement, additional part or submission for the reference data element.

The above embodiments can further involve a third stakeholder issuing the monitoring notification. The monitoring notification can be issued as a result of the third stakeholder monitoring data traffic and stakeholder agreements. The above embodiments can further involve providing the reference data element with a definition, determining how much of the definition each of the first and second stakeholders knows about the reference data element, and determining what the strict logical relationships are between these knowledge limitations. The above embodiments can further involve determining which stakeholder must supply, confirm, challenge or reject which portion of information about the reference data element, and at what time. In various embodiments, the above described system operates with a front-end application, a back-end application, a facts service and a DLT network as described elsewhere herein.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more central servers, central controllers, or remote hosts; and/or (b) one or more personal computing devices, such as desktop computers, laptop computers, tablet computers or computing devices, personal digital assistants, mobile phones, and other mobile computing devices. A system as used herein may also refer to: (c) a single central server, central controller, or remote host; and/or (d) a plurality of central servers, central controllers, or remote hosts in combination with one another.

In certain embodiments in which the system includes a central server, central controller, or remote host, the central server, central controller, or remote host is any suitable computing device (such as a server) that includes at least one processor and at least one memory device or data storage device. The processor of the additional device, central server, central controller, or remote host is configured to transmit and receive data or signals representing events, messages, commands, or any other suitable information between the central server, central controller, or remote host and the additional device.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

1. A system for facilitating consistent accuracy of multi-source financial reference data, comprising:
a processor; and
a computer-readable memory and program instructions stored by the computer-readable memory for causing the processor, when executed, to perform steps comprising:
receiving a submission related to a reference data element from a first stakeholder, wherein the reference data element has a definition;
updating a ledger according to the definition for the reference data element;
issuing, to at least a second stakeholder, at least one monitoring notification related to the reference data element;
receiving, from the second stakeholder in response to issuing the at least one monitoring notification, at least one of: a statement regarding the acceptability of the reference data element, at least one additional part of the definition of the reference data element, and at least one submission of an action to be taken on the reference data element, wherein the action is one of an addition, correction or deletion; and
updating the ledger according to the received statement, additional part or at least one submission for the reference data element.

2. The system of claim 1 wherein the instructions cause the processor, when executed, to issue the at least one monitoring notification to at least the second stakeholder upon receipt of input from the first stakeholder or a third stakeholder.

3. The system of claim 1 wherein the reference data element further has a type, and wherein the instructions cause the processor, when executed, to associate the definition with the reference data element type and determine at least a portion of the definition each of the first and second stakeholders knows about the type of reference data element.

4. The system of claim 1, wherein the reference data element further has a type, and wherein the instructions cause the processor, when executed, to determine one or more strict logical relationships between at least a portion of the definition and what each of the first and second stakeholders is defined to know about such type of reference data element.

5. The system of claim 1, wherein the instructions cause the processor, when executed, to trigger at least the first and second stakeholders to supply, confirm, challenge or reject at least a portion of information about the reference data element.

6. The system of claim 1, wherein the instructions cause the processor, when executed, to determine a time by which the second stakeholder must supply, confirm, challenge or reject at least a portion of information about the reference data element.

7. The system of claim 6, wherein the reference data element further has a type from a plurality of types, and wherein the instructions cause the processor, when executed, to administer the reference data element via a programmed computer protocol that digitally enforces the adherence of the stakeholders to a data governance model defined for each of the plurality of types of reference data element.

8. The system of claim 7, wherein the data governance model specifies, for each reference data element type, the number and type of stakeholders and the rights and duties of each stakeholder at each moment in the lifecycle of a subject reference data element of each reference data element type.

9. The system of claim 8, wherein the rights and duties include the right to consult the subject reference data element and metadata about the subject reference data element, and the duty to take action to ensure that the complete and correct set of reference data elements for each reference data element type is available to the stakeholders.

10. The system of claim 8, wherein the programmed computer protocol produces an audit trail of stakeholder actions.

11. The system of claim 8, wherein at least one of the reference data element types comprises a Cash Standing Settlement Instructions (Cash SSI) type, wherein the Cash SSI type is defined as a statement by a first party that any cash payment or settlement in a first currency and for a first type of transaction is to be executed on an account with a second party, wherein the second party is defined by the statement.

12. The system of claim 11, wherein for the Cash SSI type, the first party is a Cash SSI Owner stakeholder, the second party is a Cash SSI Nostro stakeholder, wherein a provider of a transaction messaging network is a third stakeholder, and wherein the data governance model for the Cash SSI type provides a Cash SSI duty for the Cash SSI Nostro stakeholder to accept or reject any reference data element of the Cash SSI type, and a Cash SSI right to unilaterally delete any reference data element of the Cash SSI type without needing any agreement from the Cash SSI Owner stakeholder.

13. A computer-implemented method to facilitate consistent accuracy of multi-source financial reference data, comprising:
defining a data governance model for a multi-source reference data element type, wherein the data governance model definition comprises at least a first stakeholder and a second stakeholder, at least one right for the first stakeholder, at least one right for the second stakeholder, at least one duty for the first stakeholder and at least one duty for the second stakeholder, wherein the at least one right and the at least one duty of the first stakeholder and the at least one right and the at least one duty of the second stakeholder relate to a plurality of reference data elements of the multi-source reference data element type; and
applying a programmed computer protocol to digitally enforce adherence of the first stakeholder to the at least one duty for the first stakeholder and of the second stakeholder to the at least one duty of the second stakeholder according to the defined data governance model.

14. The method of claim 13, wherein the at least one right and the at least one duty of the first stakeholder and the at least one right and the at least one duty of the second stakeholder relate to the plurality of reference data elements during a lifecycle of each of the plurality of reference data elements in order to ensure reference data element accuracy.

15. The method of claim 13, wherein the data governance model defines a portion of a definition of at least one reference data element of the plurality of reference data elements that the first stakeholder can know, and a portion of the definition of the at least one reference data element of the plurality of reference data elements that the second stakeholder can know, and wherein the data governance model further defines a strict logical relationship between at least a portion of the definition of the at least one reference data element and what each of the first and second stakeholders is defined to know about the at least one reference data element.

16. The method of claim 13, further comprising:
receiving a submission of a reference data element of the multi-source reference data element type from the first stakeholder, wherein the reference data element has a first type definition;
updating a ledger according to the first type definition;
issuing at least one notification based on the first type definition;
receiving from at least the second stakeholder, in response to the at least one notification, at least one of: a statement regarding the acceptability of the reference data element, at least one additional part of the definition of the reference data element, and at least one submission of an action to be taken on the reference data element, wherein the at least one action is one of addition, correction, or deletion; and
updating the ledger according to the received statement, additional part or at least one submission for the reference data element.

17. The method of claim 13, wherein the programmed computer protocol produces an audit trail of stakeholder actions, wherein the audit trail is cryptographically protected against modification by the first and second stakeholders.

18. The method of claim 13, wherein the reference data element type comprises a Cash Standing Settlement Instructions (Cash SSI) type, wherein the Cash SSI type is defined as a statement by the first stakeholder that any cash payment or settlement in a first currency and for a first type of transaction is to be executed on an account with the second stakeholder, wherein the second stakeholder is defined by the statement.

19. The method of claim 15, wherein for the Cash SSI type, the first stakeholder is a Cash SSI Owner stakeholder, the second stakeholder is a Cash SSI Nostro stakeholder, wherein a provider of a transaction messaging network is a third stakeholder, and wherein the data governance model for the Cash SSI type provides a Cash SSI duty for the second stakeholder to accept or reject any reference data element of the Cash SSI type, and a Cash SSI right to unilaterally delete any reference data element of the Cash SSI type without needing any agreement from the first stakeholder.
